(19) United States
(12) Patent Application Publication
(10) Pub. No.: US 2024/0195160 A1
(43) Pub. Date: Jun. 13, 2024

(54) ELECTRICAL BOX EXTENDER WITH MULTIPLE CUTAWAY FLANGE PORTIONS

(71) Applicant: THOMAS J. GRETZ, DELRAY BEACH, FL (US)

(72) Inventor: THOMAS J. GRETZ, DELRAY BEACH, FL (US)

(73) Assignee: arlington industries, inc., scranton, PA (US)

(21) Appl. No.: 18/439,741

(22) Filed: Feb. 12, 2024

Related U.S. Application Data
(60) Provisional application No. 63/431,815, filed on Dec. 12, 2022.

(51) Int. Cl. H02G 3/12

(52) U.S. Cl. CPC H02G 3/121

(57) ABSTRACT

An electrical box extender for repositioning an electrical box level with a newly installed wall surface. The box extender includes a frame member with rearward-extending side walls and end walls. The side walls and end walls extend backward from the inner periphery of the frame member. End flanges and side flanges extend from the frame member. The flanges include selectively removable flange portions including outer removable flange portions and inner removable flange portions. The removable flange portions are defined by a series of perforations, including an outer row of perforations and an inner row of perforations. The breakaway flange portions can be left intact or removed as needed for mounting of either a standard, mid-size, or max-size cover plate.

### CROSS-REFERENCE TO RELATED APPLICATIONS

This application claims priority to provisional U.S. Application No. 63/431,815, filed Dec. 12, 2022, the contents of which are incorporated herein by reference in their entirety.

### FIELD OF THE INVENTION

The present invention relates to the repositioning of electrical components within walls and similar structures and specifically to an electrical box extender for use with a range of cover plate sizes to relevel recessed components with a wall surface and to compensate for poorly cut drywall and set-back devices.

### BACKGROUND

Wall surfaces of homes are sometimes recovered with materials such as plaster, drywall, or paneling to improve the wall surface. Installation of the new wall surface typically causes electrical components, such as duplex outlets and light switches to become recessed within the new wall, leading to undesirable “set-back” in which the cover plate does not seal around the electrical box. Although the homeowner can reinstall all the electrical boxes with their components level with the newly installed surface, this becomes a labor intensive and time consuming endeavor, and usually requires the services of a certified electrician.

Although various devices have been proposed for bringing electrical components level with newly installed walls, these devices are limited to use in repositioning a standard-size cover plate. However, cover plates are now provided by manufacturers in several sizes, including standard, mid-size, and max-size. Current repositioning devices are limited for use in repositioning a standard-size cover plate and cannot be used to reposition a mid-size or max-size cover plate without extensive and time consuming modification at the job site.

Accordingly, what is needed is a box extender that can be quickly and easily used to reposition the surface an electrical component including either a standard size, mid-size, or max-size cover plate. The box extender enables simple and effective repositioning of an electrical box to render its installed component level with a newly installed wall.

### DESCRIPTION OF THE DRAWINGS

FIG. 1 is a front view of the preferred embodiment of an electrical box extender with breakaway flange according to the present invention.

FIG. 2 is an end view of the electrical box extender of FIG. 1.

FIG. 3 is a rear view of the electrical box extender.

FIG. 4 is a side view of the electrical box extender.

FIG. 5 is a sectional view of the electrical box extender taken along line 5-5 of FIG. 1.

FIG. 6 is a sectional view of the electrical box extender taken along line 6-6 of FIG. 1.

FIG. 7 is a front isometric view of the electrical box extender.

FIG. 8 is a rear isometric view of the electrical box extender.

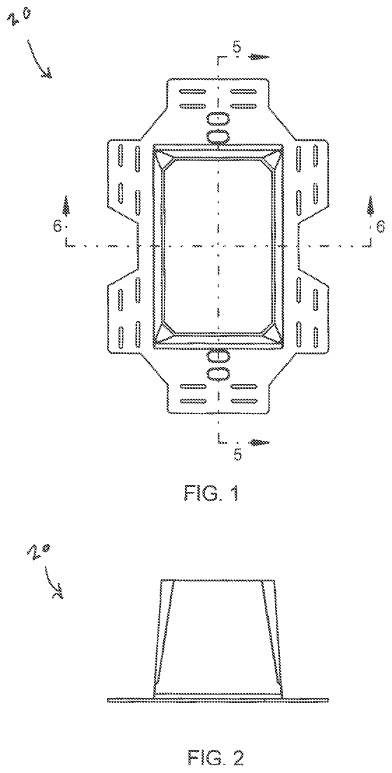

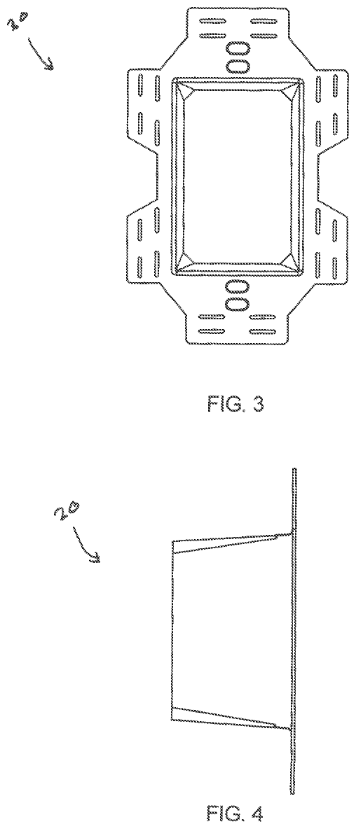

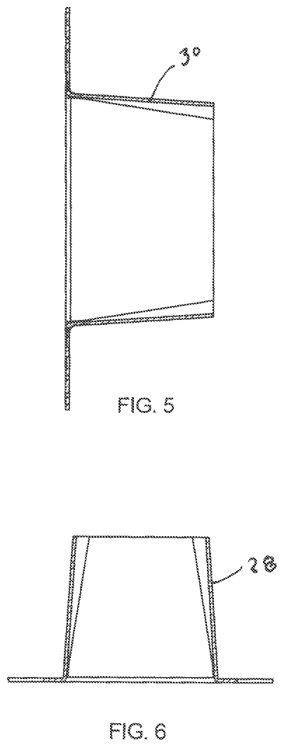

### DETAILED DESCRIPTION

With reference to FIG. 1 there is shown a preferred embodiment of an electrical box extender 20 with selectively removable flange portions according to the present invention. The box extender includes a frame

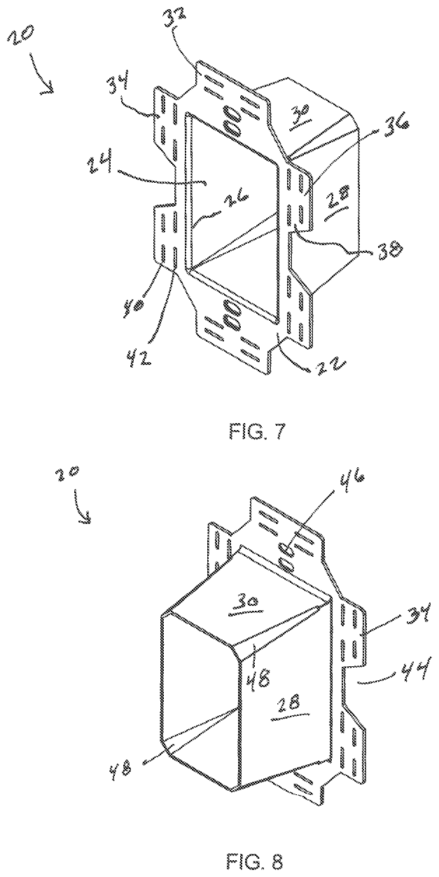

Referring to FIGS. 7 and 8, the box extender 20 includes a frame 22 with a front opening 24 including an inner periphery 26. Side walls 28 and end walls 30 extend backward from the inner periphery of the frame 22.

End flanges 32 and side flanges 34 extend outward from the frame 22. The flanges include selectively removable flange portions, including outer removable flange portions 36 and inner removable flange portions 38. The removable flange portions are defined by a series of perforations, including an outer row of perforations 40 and an inner row of perforations 42. Two side flanges 34 are provided on each side of the frame 22 and a single end flange 32 is provided on each end of the frame. The side flanges 34 are separated by a gap 44. One or more apertures 46 are provided on the end flanges 34 to accommodate insertion of screws to reconnect the electrical component to the set-back electrical box. The side walls 28 and end walls 30 are connected by corner members 48.

The box extender is a one-piece flexible member that may be inserted into an existing electrical box to bring it flush with a newly installer surface, such as when the existing box becomes recessed behind the existing wall surface. The box extender is adapted to accommodate any of three commonly used cover plates including a standard cover plate, a mid-size cover plate, or a max-size cover plate.

The box extender of the present invention will extend set-back metal or non-metallic electrical boxes up to 1½ inches. They work with any single gang device and most steel and non-metallic outlet boxes, bringing a fully supported wiring device level and flush with the existing wall surface. When used with steel boxes the box extender prevents arcing and shorting by creating a barrier between the box and the device screws.

Compared to prior art box extenders, the box extender of the present invention includes larger flange portions that provide extra device support when the wall opening is miscut or oversized. They will accommodate a standard, a mid-size, or a max-size cover plate, and they're trimmable along either the outer row of perforations 40 or the inner row of perforations 42 to trim the box extender to accommodate either a standard or mid-size cover plate or left intact to cover a max-size cover plate or to cover the open area caused by a miscut or oversized wall opening.

The box extender of the present invention is preferably constructed of plastic and most preferably is molded in one piece of plastic with the frame portion of the box substantially rigid and the side walls substantially flexible. Appropriate plastic materials for construction of the box extender include polycarbonate, polyvinyl chloride, and nylon.

Although the description above contains many specific descriptions, materials, and dimensions, these should not be construed as limiting the scope of the invention but as merely providing illustrations of some of the presently preferred embodiments of this invention. Thus the scope of the invention should be determined by the appended claims and their legal equivalents, rather than by the examples given.

I claim:

1. An electrical box extender, comprising:
a frame with a front opening including an inner periphery; and
side walls and end walls extending from the inner periphery of the frame.

2. The electrical box extender of claim 1, comprising:
two side flanges extending from each side wall; and
an end flange extending from each end wall.

3. The electrical box extender of claim 2, comprising a gap separating each of said side flanges.

4. The electrical box extender of claim 3, comprising selectively removable flange portions on said flanges.

5. The electrical box extender of claim 4, comprising said selectively removable flange portions including outer removable flange portions and inner removable flange portions.

6. The electrical box extender of claim 5, comprising said removable flange portions are defined by a series of perforations.

7. The electrical box extender of claim 6, comprising said perforations including an outer row of perforations and an inner row of perforations.

8. The electrical box extender of claim 7, comprising one or more apertures on the end flanges to accommodate insertion of screws to connect an electrical component to a set-back electrical box.

9. The electrical box extender of claim 8, comprising corner members connecting said side walls and said end walls.
